(19) United States
(12) Patent Application Publication
(10) Pub. No.: US 2016/0046092 A1
(43) Pub. Date: Feb. 18, 2016

(54) CUTTER, CUTTER SYSTEM, AND METHOD FOR SEVERING ELASTOMERIC MATERIAL FROM NON-PNEUMATIC TIRE

(71) Applicant: CATERPILLAR INC., Peoria, IL (US)

(72) Inventors: Christopher A. Kinney, Iuka, MS (US); Kegan J. Luick, Corinth, MS (US); Jarrod D. Moss, Corinth, MS (US); David J. Colantoni, Metamora, IL (US); Kevin L. Martin, Washburn, IL (US); Daniel J. Pierce, Deadwood, SD (US)

(73) Assignee: CATERPILLAR INC., Peoria, IL (US)

(21) Appl. No.: 14/457,630

(22) Filed: Aug. 12, 2014

(51) Int. Cl. B29D 30/00; B26D 3/00

(52) U.S. Cl. CPC B29D 30/0005; B26D 3/005

(57) ABSTRACT

A cutter system configured to sever elastomeric material of a non-pneumatic tire may include a cutter including a mounting fixture and a blade coupled to the mounting fixture. The cutter system may further include a driver assembly operably coupled to the mounting fixture of the cutter. The driver assembly may include a support member, and a cross-member operably coupled to the mounting fixture and the support member. The driver assembly may further include a first actuator operably coupled to the cross-member and the mounting fixture of the cutter, wherein the first actuator is configured to rotate the mounting fixture of the cutter relative to the cross-member. The driver assembly may further include a second actuator operably coupled to the cross-member and the support member, wherein the second actuator is configured to move the cross-member, such that the cutter reciprocates along a first axis relative to the support member.

### TECHNICAL FIELD

The present disclosure relates to a cutter, cutter system, and method for severing material, and more particularly, to a cutter, cutter system, and method for severing elastomeric material from a non-pneumatic tire.

### BACKGROUND

Machines such as vehicles often include tires for facilitating travel across terrain. Such tires often include a rim or hub, provide cushioning for improved comfort or protection of passengers or cargo, and provide enhanced traction via a tread of the tire. Non-pneumatic tires are an example of such tires. For example, non-pneumatic tires may be formed by supplying a material in a flowable form into a mold and after the material hardens, removing the molded tire from the mold. Such tires may be molded so that the tread is formed during the molding of the tire, such that the tire is a single, monolithic structure including the tread.

Use of such tires may result in the tread wearing down to a point rendering the tire unsuitable for its intended use. Other portions of the tire may also wear or become damaged through use, rendering the tire unsuitable for continued use. For a pneumatic tire, it is possible to merely remove the rubber tire portion from the wheel, and install a new rubber tire portion onto the wheel and inflate it, thereby acquiring a new tire having a desirable tread. However, unlike a pneumatic tire that is mounted on a wheel and inflated, it may be difficult or impractical to simply remove the portion of the non-pneumatic tire surrounding a hub and install a new portion having tread, particularly if the non-pneumatic tire is molded as a single, monolithic structure.

Therefore, it may be desirable to provide a new tread on a non-pneumatic tire without discarding the remainder of the tire and forming a new tire. Thus, it may be desirable to provide systems and methods for removing the worn tread of a non-pneumatic tire, such that the remaining tire structure may be provided in a condition that permits the molding of a new tread on the remainder of the tire. In addition, it may be desirable to provide a new elastomeric portion of a non-pneumatic tire without discarding the hub on which the remainder of the tire is formed. Thus, it may be desirable to provide systems and methods for removing the elastomeric material from a hub of the non-pneumatic tire so that new elastomeric material may be molded onto the hub. It may also be desirable to be able to sever portions out of a non-pneumatic tire in order to evaluate the characteristics of the molded material following a molding process.

An example of an apparatus and method for removing a portion of the crown of a worn pneumatic tire is described in U.S. Pat. No. 3,426,828 to Neilson (“the '828 patent”). According to the '828 patent, the crown portion is removed in preparation for application of tread stock in a tire recapping process. The '828 patent describes a process in which an inflated tire is rotated on its axis at a predetermined speed, and a knife-type cutter traverses the crown of the tire to remove a portion of the crown. Although the '828 patent purports to provide an apparatus and method for removing a portion of a crown of a pneumatic tire, it does not relate to severing the elastomeric material of a non-pneumatic tire.

The cutter and method for severing elastomeric material from a non-pneumatic tire disclosed herein may be directed to mitigating or overcoming one or more of the possible drawbacks set forth above.

### SUMMARY

According to a first aspect, the present disclosure is directed to a cutter configured to sever elastomeric material of a non-pneumatic tire. The cutter may include a mounting fixture configured to be operably coupled to an actuator, and a guide associated with the mounting fixture. The guide may include an elongated rod-like member having a longitudinal axis. The cutter may further include a blade configured to sever the elastomeric material, wherein the blade is operably coupled to the guide and extends along the longitudinal axis of the guide. The blade may have a cutting edge remote from the mounting fixture.

According to a further aspect, the present disclosure is directed to a cutter configured to sever elastomeric material of a non-pneumatic tire. The cutter may include a mounting fixture configured to be operably coupled to an actuator, and a blade configured to sever the elastomeric material. The blade may be operably coupled to the mounting fixture, and the blade may have a cutting edge remote from the mounting fixture. The mounting fixture may include a plate configured to be operably coupled to an actuator.

According to another aspect, the present disclosure is directed to a method for removing elastomeric material from a non-pneumatic tire. The method may include coupling a cutter to a machine having an actuator. The cutter may include a mounting fixture operably coupled to the actuator, and a blade configured to sever the elastomeric material. The blade may be operably coupled to the mounting fixture. The method may further include operating the actuator such that the blade moves in a plane substantially perpendicular to an equatorial plane of the non-pneumatic tire and cuts into the elastomeric material of the non-pneumatic tire.

According to a further aspect, the present disclosure is directed to a cutter system configured to sever elastomeric material of a non-pneumatic tire. The cutter system may include a cutter including a mounting fixture and a blade coupled to the mounting fixture. The blade may include a cutting edge configured to sever the elastomeric material. The cutter system may further include a driver assembly operably coupled to the mounting fixture of the cutter. The driver assembly may include a support member, and a cross-member operably coupled to the mounting fixture of the cutter and the support member. The driver assembly may further include a first actuator operably coupled to the cross-member and the mounting fixture of the cutter, wherein the first actuator is configured to rotate the mounting fixture of the cutter relative to the cross-member. The driver assembly may further include a second actuator operably coupled to the cross-member and the support member, wherein the second actuator is configured to move the cross-member, such that the cutter reciprocates along a first axis relative to the support member.

According to another aspect, the present disclosure is directed to a method for removing elastomeric material from a non-pneumatic tire. The method may include placing a non-pneumatic tire on a support, and positioning a cutter system relative to the non-pneumatic tire, with the cutter system being configured to sever a portion of the elastomeric material. The cutter system may include a cutter including a blade having a cutting edge configured to sever the elastomeric material, and a driver assembly operably coupled to cutter. The driver assembly may include a support member operably coupled the cutter, and an actuator operably coupled to the cutter and the support member. The actuator may be configured such that upon activation the cutter reciprocates along a first axis substantially perpendicular to an equatorial plane of the non-pneumatic tire. The method may further include activating the actuator such that the cutter severs a portion of the elastomeric material.

### BRIEF DESCRIPTION OF THE DRAWINGS

FIG. 1 is a side view of an exemplary embodiment of a machine including an exemplary embodiment of a non-pneumatic tire.

FIG. 2 is a perspective view of an exemplary embodiment of a non-pneumatic tire.

FIG. 3 is a partial section view of an exemplary embodiment of a non-pneumatic tire.

FIG. 4 is perspective view of an exemplary embodiment of a cutter for severing elastomeric material from a non-pneumatic tire and an exemplary non-pneumatic tire.

FIG. 5 is a partial section view of an exemplary embodiment of a cutter and an exemplary non-pneumatic tire with the cutter positioned to sever material of the non-pneumatic tire.

FIG. 6 is a schematic view of exemplary cut lines for severing material from an exemplary non-pneumatic tire.

FIG. 7 is a perspective view of an exemplary embodiment of a cutter.

FIG. 8 is a perspective view of another exemplary embodiment of a cutter.

FIG. 9 is a perspective view of another exemplary embodiment of a cutter.

FIG. 10 is a perspective view of another exemplary embodiment of a cutter.

FIG. 11 is perspective view of an exemplary embodiment of a cutter operably coupled to an exemplary machine for severing elastomeric material of an exemplary non-pneumatic tire.

FIG. 12 is a perspective view of an exemplary embodiment of a cutter system for severing elastomeric material from a non-pneumatic tire.

FIG. 13 is a perspective view of another exemplary embodiment of a cutter system for severing elastomeric material from a non-pneumatic tire shown in a collapsed orientation.

FIG. 14 is a perspective view of the exemplary cutter system shown in FIG. 13 shown in a semi-collapsed orientation.

FIG. 15 is a perspective view of the exemplary cutter system shown in FIG. 13 shown in an upright orientation for severing elastomeric material of an exemplary non-pneumatic tire.

FIG. 16 is a perspective view of an exemplary embodiment of a cutter system operably coupled to an exemplary machine.

### DETAILED DESCRIPTION

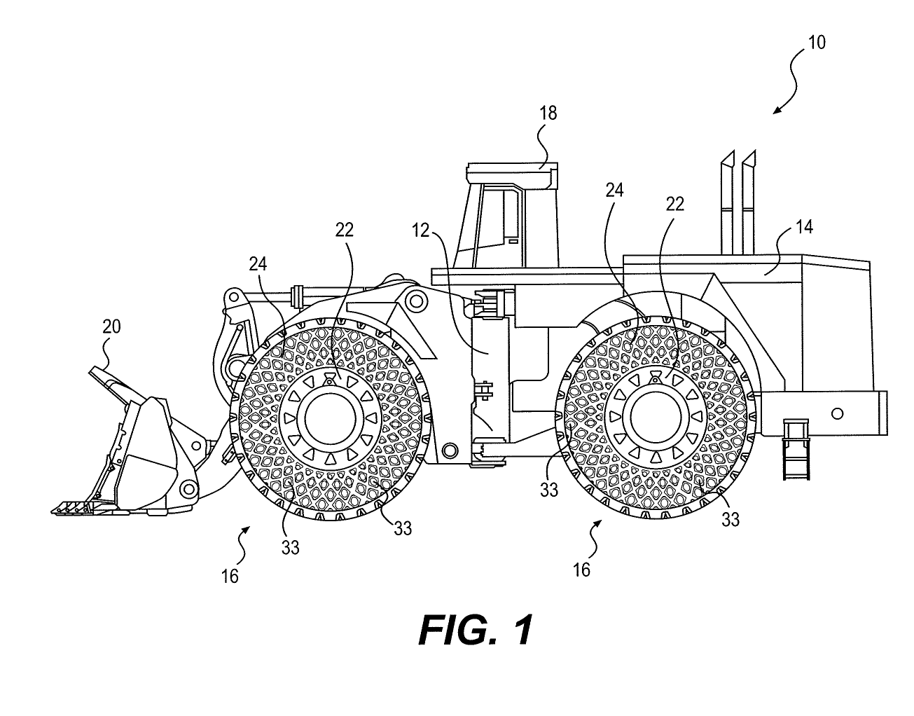

FIG. 1 shows an exemplary machine 10 configured to travel across terrain. Exemplary machine 10 shown in FIG. 1 is a wheel loader. However, machine 10 may be any type of ground-borne vehicle, such as, for example, an automobile, a truck, an agricultural vehicle, and/or a construction vehicle, such as, for example, a dozer, a skid-steer loader, an excavator, a grader, an on-highway truck, an off-highway truck, and/or any other vehicle type known to a person skilled in the art. In addition to self-propelled machines, machine 10 may be any device configured to travel across terrain via assistance or propulsion from another machine.

Exemplary machine 10 shown in FIG. 1 includes a chassis 12 and a powertrain 14 coupled to and configured to supply power to wheels 16, so that machine 10 is able to travel across terrain. Machine 10 also includes an operator station 18 to provide an operator interface and protection for an operator of machine 10. Machine 10 also includes a bucket 20 configured to facilitate movement of material. As shown in FIG. 1, exemplary wheels 16 include a hub 22 coupled to powertrain 14, and tires 24 coupled to hubs 22. Exemplary tires 24 are molded tires, such as, for example, molded, non-pneumatic tires.

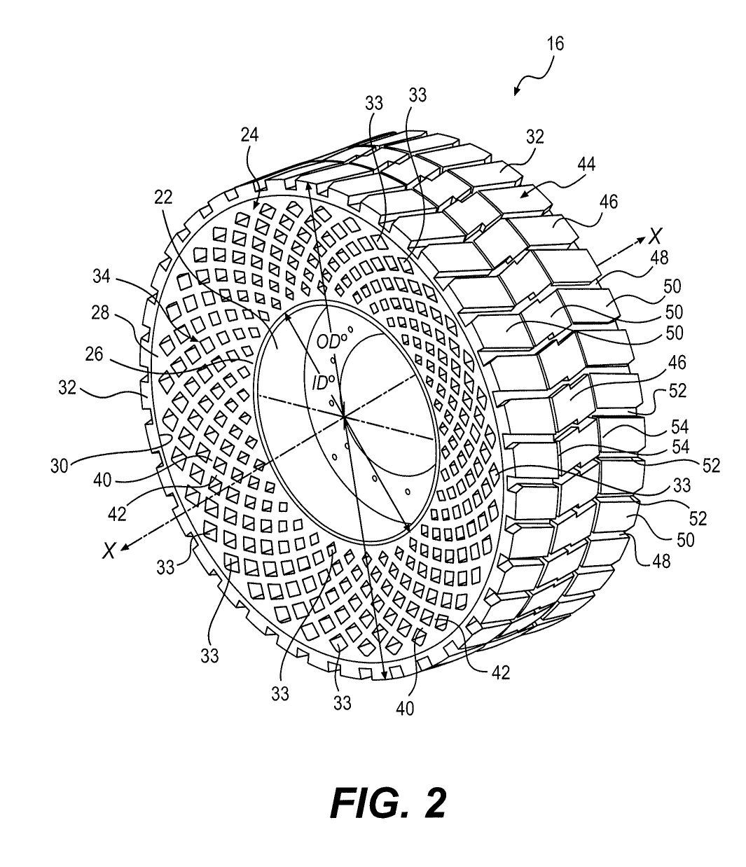

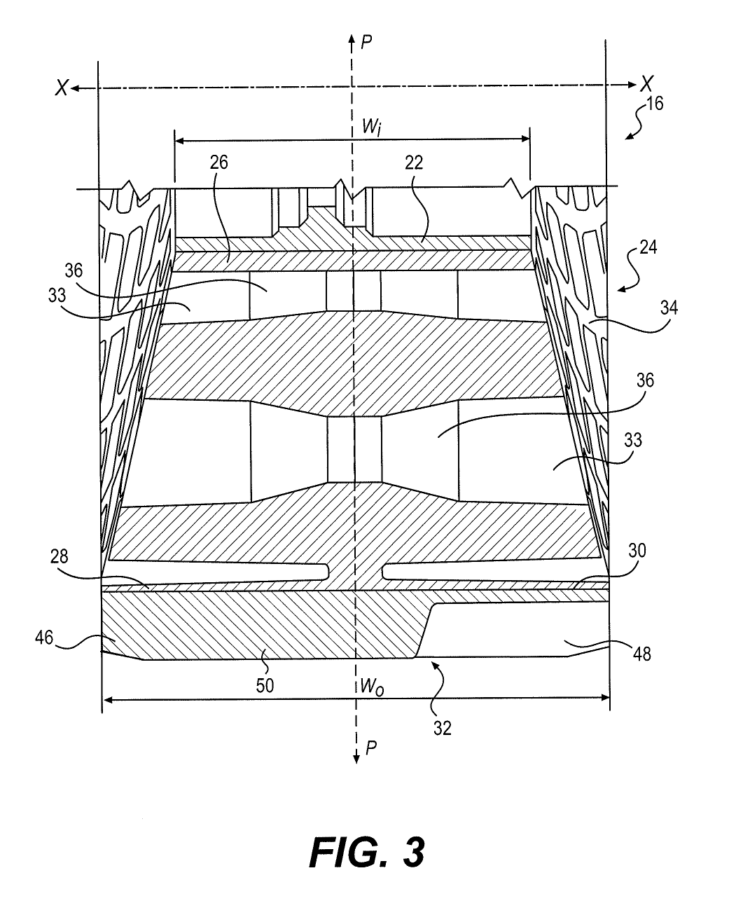

The exemplary tire 24 shown in FIGS. 2 and 3 includes an inner circumferential portion 26 configured to be coupled to a hub 22, and an outer circumferential portion 28 configured to be coupled to an inner surface 30 of a tread portion 32 configured to improve traction of tire 24 at the interface between tire 24 and the terrain across which tire 24 rolls. Extending between inner circumferential portion 26 and outer circumferential portion 28 is a support structure 34. Exemplary support structure 34 serves to couple inner circumferential portion 26 and outer circumferential portion 28 to one another. As shown in FIGS. 1-3, exemplary tire 24 includes a plurality of cavities 33 configured to provide support structure 34 with a desired level of support and cushioning for tire 24. According to some embodiments, one or more of cavities 33 may have an axial intermediate region 36 having a relatively smaller cross-section than the portion of cavities 33 closer to the axial sides of tire 24.

According to some embodiments, one or more of inner circumferential portion 26 and outer circumferential portion 28 are part of support structure 34. Hub 22 and/or inner circumferential portion 26 may be configured to facilitate coupling of hub 22 to inner circumferential portion 26. According to some embodiments, support structure 34, inner circumferential portion 26, outer circumferential portion 28, and/or tread portion 32 are integrally formed as a single, monolithic piece, for example, via molding. For example, tread portion 32 and support structure 34 may be chemically bonded to one another. For example, the material of tread portion 32 and the material of support structure 34 may be covalently bonded to one another. According to some embodiments, support structure 34, inner circumferential portion 26, and/or outer circumferential portion 28 are integrally formed as a single, monolithic piece, for example, via molding, and tread portion 32 is formed separately in time and/or location and is joined to support structure 34 in a common mold assembly to form a single, monolithic piece. Even in such embodiments, tread portion 32 and support structure 34 may be chemically bonded to one another. For example, the material of tread portion 32 and the material of support structure 34 may be covalently bonded to one another.

Exemplary tire 24, including inner circumferential portion 26, outer circumferential portion 28, tread portion 32, and support structure 34, may be configured to provide a desired amount of traction and cushioning between a machine and the terrain. For example, support structure 34 may be configured to support the machine in a loaded, partially loaded, and empty condition, such that a desired amount of traction and/or cushioning is provided, regardless of the load.

For example, if the machine is a wheel loader as shown in FIG. 1, when its bucket is empty, the load on one or more of wheels 24 may range from about 60,000 lbs. to about 160,000 lbs. (e.g., 120,000 lbs.). In contrast, with the bucket loaded with material, the load on one or more of wheels 16 may range from about 200,000 lbs. to about 400,000 lbs. (e.g., 350,000 lbs.). Tire 24 may be configured to provide a desired level of traction and cushioning, regardless of whether the bucket is loaded, partially loaded, or empty. For smaller machines, correspondingly lower loads are contemplated. For example, for a skid-steer loader, the load on one or more of wheels 16 may range from about 1,000 lbs. empty to about 3,000 lbs. (e.g., 2,400 lbs.) loaded.

Exemplary support structure 34 shown in FIG. 2 has a plurality of first ribs 40 extending in a first circumferential direction between inner circumferential portion 26 and outer circumferential portion 28. For example, in some embodiments, at least some of first ribs 40 are coupled to inner circumferential portion 26 and outer circumferential portion 28 and extend therebetween, as shown in FIG. 2. Similarly, in some embodiments, support structure 34 includes a plurality of second ribs 42 extending in a second circumferential direction opposite the first circumferential direction between inner circumferential portion 26 and outer circumferential portion 28. For example, in some embodiments, at least some of second ribs 42 are coupled to inner circumferential portion 26 and outer circumferential portion 28 and extend therebetween, as shown in FIG. 2. According to some embodiments, at least some of first ribs 40 and some of second ribs 42 intersect one another such that they share common material at points of intersection. In addition, at least some of first ribs 40 and at least some of second ribs 42 form cavities 33 in support structure 34.

As shown in FIG. 2, according to some embodiments, each of first ribs 40 may have a cross-section perpendicular to the axial direction having a first curvilinear shape. In some embodiments, the first curvilinear shape may be a curve having a single direction of curvature (see, e.g., FIG. 2) as first ribs 40 extend between inner circumferential portion 26 and outer circumferential portion 28. In some embodiments, the first curvilinear shape may be a curve having a direction of curvature that changes once as first ribs 40 extend between inner circumferential portion 26 and outer circumferential portion 28. Similarly, each of second ribs 42 may have a cross-section perpendicular the axial direction of tire 24 having a second curvilinear shape. In some embodiments, the second curvilinear shape may be a curve having a single direction of curvature (see, e.g., FIG. 2) as second ribs 42 extend between inner circumferential portion 26 and outer circumferential portion 28. In some embodiments, the second curvilinear shape may be a curve having a direction of curvature that changes once as second ribs 42 extend between inner circumferential portion 26 and outer circumferential portion 28.

Tire 24 may have dimensions tailored to the desired performance characteristics based on the expected use of the tire. For example, exemplary tire 24 may have an inner diameter ID for coupling with hub 22 ranging from 0.5 meters to 4 meters (e.g., 2 meters), and an outer diameter OD ranging from 0.75 meters to 6 meters (e.g., 4 meters) (see FIG. 2). According to some embodiments, the ratio of the inner diameter ID of tire 24 to the outer diameter OD of tire 24 ranges from 0.25:1 to 0.75:1, or 0.4:1 to 0.6:1, for example, about 0.5:1. Support structure 34 may have an inner axial width W, at inner circumferential portion 26 (see FIG. 3) ranging from 0.05 meters to 3 meters (e.g., 0.8 meters), and an outer axial width Wₒ at outer circumferential portion 28 ranging from 0.1 meter to 4 meters (e.g., 1 meter). For example, exemplary tire 24 may have a trapezoidal cross-section (see FIG. 3). Other dimensions are contemplated. For example, for smaller machines, correspondingly smaller dimensions are contemplated.

According to some embodiments, tread portion 32 is formed from a first polyurethane having first material characteristics, and support structure 34 is formed from a second polyurethane having second material characteristics different than the first material characteristics. According to some embodiments, tread portion 32 is chemically bonded to support structure 34. For example, at least some of the first polyurethane of tread portion 32 is covalently bonded to at least some of the second polyurethane of support structure 34. This may result in a superior bond as compared with bonds formed via adhesives, mechanisms, or fasteners.

As a result of the first material characteristics of the first polyurethane being different than the second material characteristics of the second polyurethane, it may be possible to tailor the characteristics of tread portion 32 and support structure 34 to characteristics desired for those respective portions of tire 24. For example, the second polyurethane of support structure 34 may be selected to be relatively stiffer and/or stronger than the first polyurethane of tread portion 32, so that support structure 34 may have sufficient stiffness and strength to support the anticipated load on tires 24. According to some embodiments, the first polyurethane of tread portion 32 may be selected to be relatively more cut-resistant and wear-resistant and/or have a higher coefficient of friction than the second polyurethane, so that regardless of the second polyurethane selected for support structure 34, tread portion 32 may provide the desired wear and/or traction characteristics for tire 24.

For example, the first polyurethane of tread portion 32 may include polyurethane urea materials based on one or more of polyester, polycaprolactone, and polycarbonate polyols that may provide relatively enhanced abrasion resistance. Such polyurethane urea materials may include polyurethane prepolymer capped with methylene diisocyanate (MDI) that may phase-segregate and form materials with relatively enhanced crack propagation resistance. Alternative polyurethanes capped with toluene diisocyanate (TDI), napthalene diisocyanate (NDI), and/or para-phenylene diisocyanate (PPDI) may also be used. Such polyurethane prepolymer materials may be cured with aromatic diamines that may also encourage strong phase segregation. Exemplary aromatic diamines include methylene diphenyl diamine (MDA) that may be bound in a salt complex such as tris (4,4′-diamino-diphenyl methane) sodium chloride (TDDM).

According to some embodiments, the first polyurethane may have a Shore hardness ranging from about from 60A to about 60D (e.g., 85 Shore A). For certain applications, such as those with soft ground conditions, it may be beneficial to form tread portion 32 from a material having a relatively harder durometer to generate sufficient traction through tread penetration. For applications such as those with hard or rocky ground conditions, it may be beneficial to form tread portion 32 from a material having a relatively lower durometer to allow conformability of tread portion 32 around hard rocks.

According to some embodiments, the second polyurethane of support structure 34 may include polyurethane urea materials based on one or more of polyether, polycaprolactone, and polycarbonate polyols that may provide relatively enhanced fatigue strength and/or a relatively low heat build-up (e.g., a low tan δ). For example, for high humidity environments it may be beneficial for the second polyurethane to provide a low tan 6 for desired functioning of the tire after moisture absorption. Such polyurethane urea materials may include polyurethane prepolymer capped with methylene diisocyanate (MDI) that may strongly phase segregate and form materials having relatively enhanced crack propagation resistance, which may improve fatigue strength. Alternative polyurethanes capped with toluene diisocyanate (TDI), napthalene diisocyanate (NDI), or para-phenylene diisocyanate (PPDI) may also be used. Such polyurethane prepolymer materials may be cured with aromatic diamines that may also encourage strong phase segregation. Exemplary aromatic diamines include methylene diphenyl diamine (MDA) that may be bound in a salt complex such as tris (4,4′-diamino-diphenyl methane) sodium chloride (TDDM). Chemical crosslinking in the polyurethane urea may provide improved resilience to support structure 34. Such chemical crosslinking may be achieved by any means known in the art, including but not limited to: the use of tri-functional or higher functionality prepolymers, chain extenders, or curatives; mixing with low curative stoichiometry to encourage biuret, allophanate, or isocyanate formation; including prepolymer with secondary functionality that may be cross-linked by other chemistries (e.g., by incorporating polybutadiene diol in the prepolymer and subsequently curing such with sulfur or peroxide crosslinking). According to some embodiments, the second polyurethane of support structure 34 (e.g., a polyurethane urea) may have a Shore hardness ranging from about 80A to about 95 A (e.g., 92A).

Some embodiments of tire 24 may include an intermediate portion between outer circumferential portion 28 and inner surface 30 of tread portion 32. For example, outer circumferential portion 28 of support structure 34 may be chemically bonded to inner surface 30 of tread portion 32 via the intermediate portion. For example, the intermediate portion may have an outer circumferential surface chemically bonded to inner surface 30 of tread portion 32, and an inner circumferential surface chemically bonded to outer circumferential portion 28 of support structure 34.

According to some embodiments, the intermediate portion may be formed from a third polyurethane. According to some embodiments, the third polyurethane may be at least similar (e.g., the same) chemically to either the first polyurethane or the second polyurethane. According to some embodiments, the third polyurethane may be chemically different than the first and second polyurethanes. For example, according to some embodiments, the third polyurethane may be mixed with a stoichiometry that is prepolymer rich (e.g., isocyanate rich). That is, in a polyurethane urea system there is a theoretical point where each isocyanate group will react with each curative (amine) functional group. Such a point would be considered to correspond to a stoichiometry of 100%. In a case where excess curative (diamine) is added, the stoichiometry would be considered to be greater than 100%. In a case where less curative (diamine) is added, the stoichiometry would be considered to be less than 100%. For example, if a part is formed with a stoichiometry less than 100%, there will be excess isocyanate functionality remaining in the part. Upon high temperature postcuring of such a part (e.g., subjecting the part to a second heating cycle following an initial, incomplete curing), the excess isocyanate groups will react to form urea linkages, biuret linkages, and isocyanurates through cyclo-trimerization, or crosslinks through allophanate formation. According to some embodiments, the third polyurethane may be chemically similar to the support structure 34 polyurethane, but formulated to range from about 50% to about 90% of theoretical stoichiometry (i.e., from about 50% to about 90% “stoichiometric”) (e.g., from about 60% to about 80% stoichiometric (e.g., about 75% stoichiometric)). Such polyurethane urea, even after forming an initial structure following so-called “green curing,” is still chemically active through the excess isocyanate functional groups.

In such embodiments, the third polyurethane may be molded into a self-supporting shape and thereafter continue to maintain its ability to chemically react or bond with the first and second polyurethanes, even if the first and second polyurethanes are substantially stoichiometric, by post-curing the first, second, and third polyurethanes together, for example, at a temperature of greater than at least about 150° C. (e.g., greater than at least about 160° C.) for a duration ranging from about 6 hours to about 18 hours (e.g., from 8 hours to 16 hours). A self-supporting intermediate portion of third polyurethane may be inserted into a mold for forming tire 24, and the first and second polyurethanes may be supplied to the mold on either side of the intermediate portion, such that the intermediate portion is embedded in tire 24 between tread portion 32 and support structure 34. According to some embodiments, the first and second polyurethanes are substantially stoichiometric prior to curing (e.g., from about 95% to about 98% stoichiometric).

According to some embodiments, the intermediate portion may have a different color than one or more of tread portion 32 and support structure 34. This may provide a visual indicator of the wear of tread portion 32. This may also provide a visual indicator when shaving, milling, and/or cutting-off tread portion 32 during a process of retreading tire 24 with a new tread portion. For example, as explained in more detail below, when tread portion 32 becomes undesirably worn, the remaining material of tread portion 32 may be shaved, milled, or cut-off down to the intermediate portion (or support structure 34), so that a new tread portion can be molded onto the intermediate portion (or support structure 34) of tire 24. By virtue of the intermediate portion (or support structure 34) being a different color than tread portion 32, it may be relatively easier to determine when sufficient shaving, milling, and/or cutting has occurred to expose the intermediate portion (or support structure 34).

According to some embodiments, the intermediate portion may include a semi-permeable membrane configured to permit chemical bonding between the first polyurethane and the second polyurethane. For example, the first polyurethane and the second polyurethane may be covalently bonded to one another via (e.g., through) the semi-permeable membrane. For example, the intermediate portion may include at least one of fabric and paper, such as, for example, flexible filter paper (e.g., a phenolic-impregnated filter paper) or an elastic fabric such as, for example, SPANDEX®. The fabric or paper may be supported in a mold for forming tire 24 via a frame such as spring-wire cage, and the first and second polyurethanes may be supplied to the mold on either side of the fabric or paper of the intermediate portion, such that the intermediate portion is embedded in tire 24 between tread portion 32 and support structure 34.

As shown in FIGS. 2 and 3, tread portion 32 may be provided to improve the traction provided by tire 24. For example, exemplary tread portion 32 includes a predetermined pattern 44 of protrusions 46 and recesses 48. Exemplary predetermined pattern 44 includes a plurality of tread blocks 50 separated circumferentially from one another by a plurality of transverse- or axially-extending grooves 52 and a plurality of circumferentially-extending channels 54. Predetermined pattern 44 may be configured to provide a desired level of traction depending on, for example, the terrain over which machine 10 is intended to travel.

With use, tread portion 32 may become damaged or worn to a point where it no longer provides a desirable amount of traction. Alternatively, it may be desirable to have a tread portion 32 with an alternative predetermined pattern 44. Thus, it may be desirable to replace or change tread portion 32, while continuing to use the same hub 22 and support structure 34, which may continue to be in a usable condition. Alternatively, support structure 34 may become damaged or worn (e.g., it may develop cracks via fatigue) to a point where it is no longer usable or no longer provides the desired level of support and/or cushioning. Thus, it may be desirable to substantially remove (e.g., completely remove) the elastomeric material of support structure 34 and tread portion 32 from hub 22, which may continue to be usable, and form a new non-pneumatic tire using the reclaimed hub.

When molding a new tread portion onto support structure 34, it may be desirable for support structure 34 to be in a condition that facilitates the molding of a new tread portion onto outer circumferential portion 28. In order to form a more durable and acceptable new tread portion, it may be desirable to remove any remaining tread portion 32 from tire 24 to provide a surface more receptive to the new tread portion, such that the new tread portion is securely fixed onto outer circumferential portion 28. In addition, when molding a new tread portion 32 and support structure 34 onto a hub 22, it may be desirable for hub 22 to be in a condition that facilitates the molding of a new support structure 34 and tread portion 32 onto hub 22. Thus, it may be desirable to remove any remaining tread portion 32 and support structure 34 from hub 22 to provide hub 22 with a surface more receptive to the new support structure, such that the new support structure is securely fixed onto hub 22.

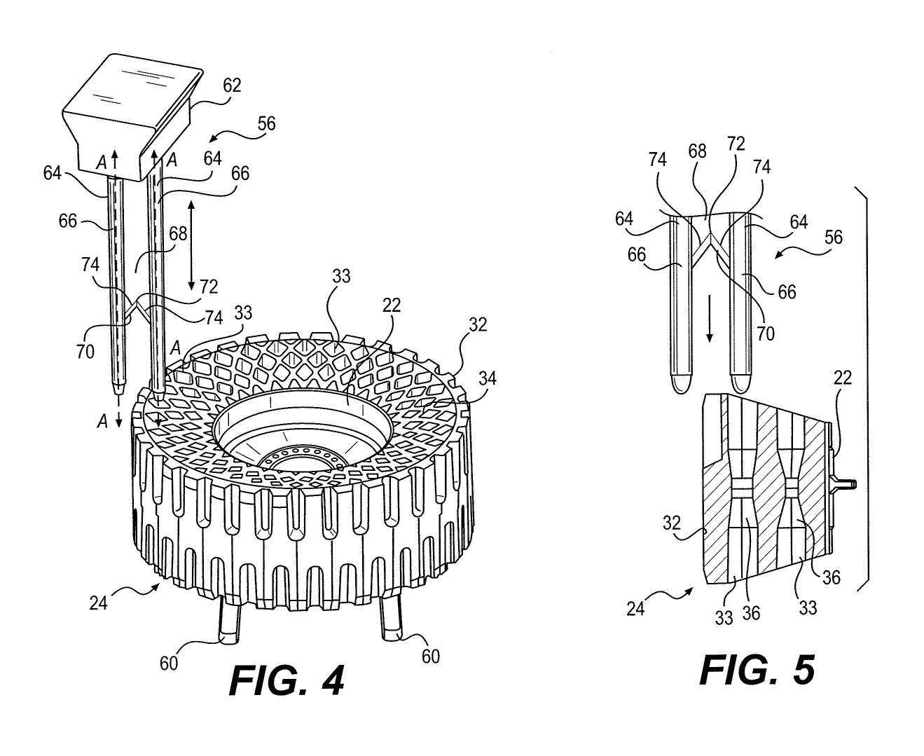

FIGS. 4-16 show exemplary embodiments of cutters 56 and cutter systems 58 configured to sever the elastomeric material of exemplary embodiments of a non-pneumatic tire. For example, at least some of the exemplary embodiments may be used for removing the tread portion from the support structure of a non-pneumatic tire and/or the support structure of a non-pneumatic tire from the hub, or for removing portions of the elastomeric material for, for example, evaluating one or more characteristics of the elastomeric material of the tread portion and/or support structure following the molding process. According to some embodiments, cutters 56 and cutter systems 58 may be configured to be used at a job worksite. For example, some cutters 56 and cutter systems 58 may be portable. According to some embodiments, some cutters 56 and cutter systems 58 may be configured to be used at a central location receiving tires from a number of job worksites, for example, at a facility configured to use cutters 56 and/or cutter systems 58 to remove at least portions of the elastomeric material from tires 24.

For example, FIG. 4 shows exemplary embodiments of a cutter 56 and a tire 24 positioned on exemplary supports 60. For the exemplary embodiments shown, cutter 56 is configured to sever elastomeric material of non-pneumatic tire 24. For example, cutter 56 may be coupled to an actuator and/or machine such that cutter 56 reciprocates into and out of tire 24, thereby severing portions of the elastomeric material of tire 24. According to some embodiments, the reciprocating action is substantially perpendicular to an equatorial plane P of tire 24 (see FIG. 3). According to some embodiments, severing of tire 24 may be facilitated by use of a lubricant (e.g., a tire beading lubricant) to render it relatively easier to drive cutter 56 into the elastomeric material and/or withdraw cutter 56 from the severed elastomeric material following insertion of cutter 56 into the elastomeric material. According to some embodiments, portions of cutter 56 may be coated with a material to render it relatively easier to drive cutter 56 into the elastomeric material and/or withdraw cutter 56. For example, all or portions of cutter 56 may be coated with TEFLON® or a TEFLON®-like material, which may be baked on. In such embodiments, the coating may be configured to at least one of facilitate sliding of cutter 56 relative to the elastomeric material and provide wear resistance to cutter 56. Other similar coating materials are contemplated.

Exemplary cutter 56 shown in FIG. 4 includes a mounting fixture 62 configured to be operably coupled to an actuator, as explained in more detail herein. According to some embodiments, cutter 56 includes one or more guides 64 associated with mounting fixture 62. For example, as shown in FIG. 4, cutter 56 includes two guides 64, each including an elongated rod-like member 66 having a longitudinal axis A. Exemplary cutter 56 also includes a blade 68 configured to sever the elastomeric material. Exemplary blade 68 is operably coupled to guides 64 and extends along the longitudinal axis A of each of guides 64. As shown, blade 68 includes a cutting edge 70 remote from mounting fixture 62.

As shown in FIGS. 4 and 5, exemplary cutter 56 includes two spaced guides 64, with the ends of guides 64 remote from mounting fixture 62 being tapered. In the exemplary embodiment shown, cutting edge 70 of blade 68 is closer to mounting fixture 62 than the remote ends of guides 64. According to some embodiments, cutting edge 70 of blade 68 and the remote ends of guides 64 may be at substantially the same longitudinal location relative to mounting fixture 62, or the remote ends of guides 64 may be closer to mounting fixture 62 than cutting edge 70 of blade 68. According the exemplary embodiments shown in FIGS. 4 and 5, blade 68 is operably coupled between first and second guides 64, such that first and second guides 64 are spaced from one another, and such that the elongated axes A of first and second guides 64 are substantially parallel to one another. According to some embodiments, cutting edge 70 of blade 68 includes at least one apex 72 between two lateral portions 74, and the one or more apexes 72 are closer to mounting fixture 62 than lateral portions 74.

According to some embodiments, one or more guides 64 may be used to assist a person using cutter 56 to sever the elastomeric material of a tire. For example, exemplary tire 24 shown in FIG. 4 includes a plurality of cavities 33 in support structure 34. As shown in FIG. 5, cutter 56 may be positioned relative to tire 24 such that one or more of longitudinal axes A of guides 64 may be substantially aligned with cavities 33, such that apex 72 of cutting edge 70 is substantially aligned with the elastomeric material between cavities 33 (e.g., with first ribs 40, second ribs 42, or tread portion 32). According to some embodiments, if cutter 64 has two guides 64, the two guides 64 may be substantially aligned with, for example, two adjacent cavities 33. In this exemplary manner, the material between cavities 33 may be severed by cutter 56.

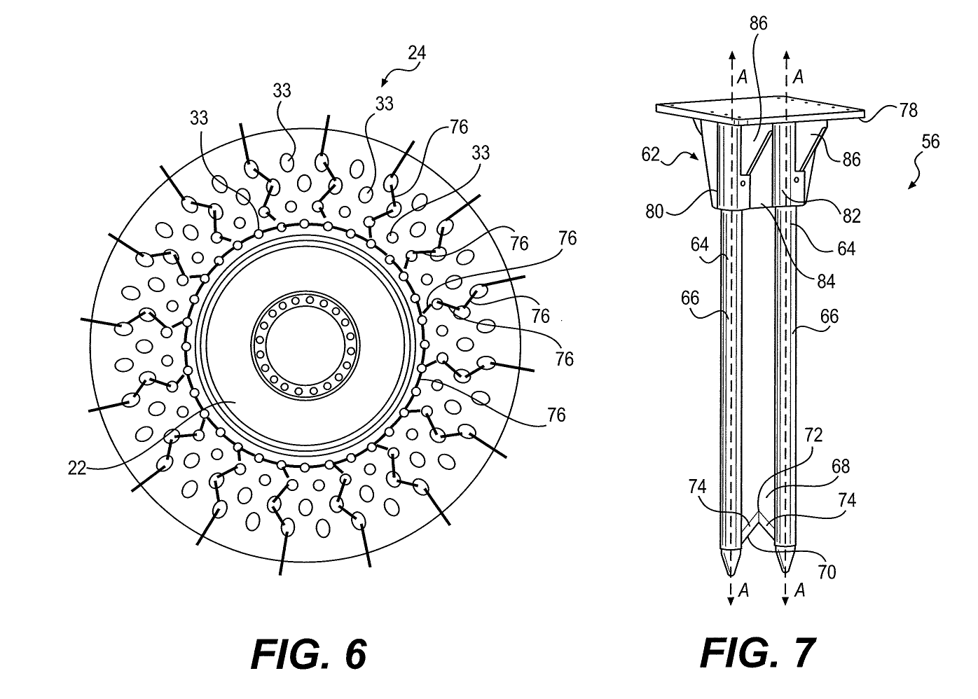

According to some embodiments, guides 64 may have a cross-section perpendicular to longitudinal axis A having a largest dimension (e.g., a diameter) slightly smaller than the smallest dimension of the cross-section of cavities 33 (e.g., the dimension of intermediate region 36), such that guides 64 may be inserted substantially through the length of cavities 33 as cutter 56 severs the elastomeric material between cavities 33 or between a cavity 33 and an exterior surface of tread portion 32. For example, FIG. 6 schematically shows exemplary cut lines 76 for severing the elastomeric material of an exemplary tire 24, for example, by substantially aligning guides 64 with cavities 33. According to some embodiments, different size cutters (e.g., cutters having different spacing between guides and/or guides having different lengths and/or cross-sectional dimensions) may be used to sever the elastomeric material of different size tires, or tires having cavities with different spacing and/or different cross-sectional dimensions.

As shown in FIG. 6, exemplary cut lines 76 may be arranged to remove substantially all of the elastomeric material from hub 22, including tread portion 32 and support structure 34. According to some embodiments, cut lines 76 may be arranged to remove substantially all of the elastomeric material of tread portion 32 while leaving the elastomeric material of support structure 34 substantially intact. Alternative arrangements of cut lines 76 are contemplated.

The exemplary embodiment of cutter 56 shown in FIG. 7 includes a mounting fixture 62 including a plate 78 configured to be operably coupled to an actuator, a first tubular mount 80 operably coupled to plate 78, and a second tubular mount 82 operably coupled to plate 78, which is substantially orthogonal with respect to blade 68. First tubular mount 80 is configured to receive a portion of one of guides 64, and second tubular mount 82 is configured to operably receive an end of a second one of guides 64, as shown in FIG. 7. In the exemplary embodiment shown, first and second tubular mounts 80 and 82 are coupled together via web 84 and are braced via gussets 86, which provide support to the connection between blade 68 and plate 78. According to some embodiments, mounting fixture 62 may be configured to receive guides 64 having different dimensions (e.g., different lateral spacing and/or cross-sectional shapes/dimensions) for severing the material of different types/sizes of non-pneumatic tires.

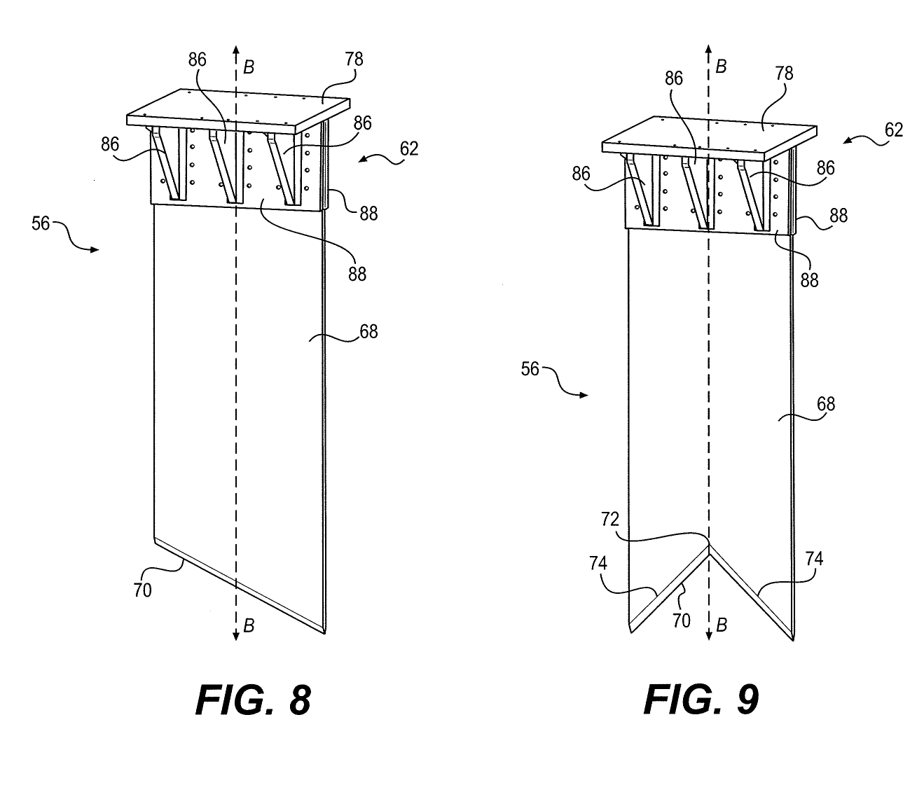

According to some embodiments, cutter 56 may not include any guides. For example, FIGS. 8-10 show exemplary embodiments of cutters 56 that do not include guides. Rather, the exemplary embodiments shown in FIGS. 8-10 are substantially free of support along the length of their respective blades 68 in a direction parallel to the longitudinal axes B of the blades 68. In the exemplary embodiments shown in FIGS. 8-10, mounting fixture 62 includes plate 78 and a pair of opposed support members 88 between which an end of blade 68 is sandwiched. Plate 78 extends substantially orthogonal with respect to blade 68, and gussets 86 may be provided to support the connection between blade 68 and plate 78.

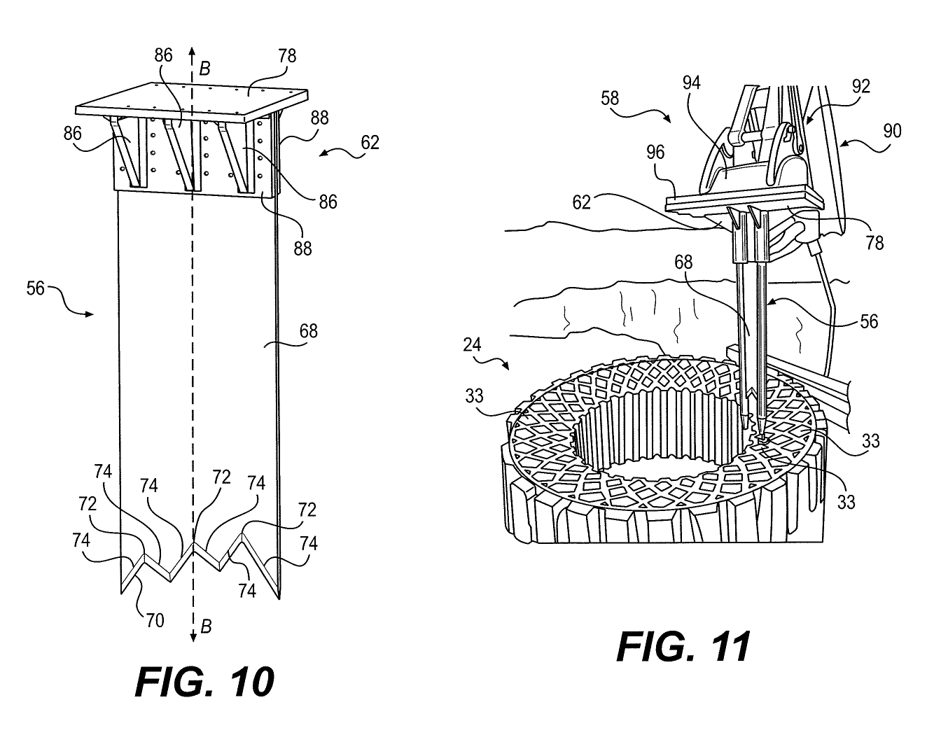

As shown in FIG. 8, exemplary blade 68 includes cutting edge 70 extending obliquely with respect to a longitudinal axis B of blade 68. This may promote an initial severing of the elastomeric material as blade 68 is driven into tire 24. Exemplary blade 68 shown in FIG. 9 includes an apex 72 between lateral portions 74, with cutting edge 70 having two portions that extend obliquely with respect to longitudinal axis B. This centrally-located apex 72 may promote centering of blade 68 relative to a portion of elastomeric material of tire 24 (e.g., at a rib of support structure 34). Exemplary blade 68 shown in FIG. 10 includes a plurality of apexes 72 (i.e., three) between lateral portions 74, with cutting edge 70 having six portions that extend obliquely with respect to longitudinal axis B. This exemplary configuration may promote initiation of the severing of the elastomeric material as blade 68 is driven into tire 24.

According to some embodiments, blade 68 may be formed of, for example, hardened steel or other materials having similar properties. According to some embodiments, blade 68 may have a thickness in a direction perpendicular to the longitudinal axis B ranging from, for example, about one-eighth of an inch to about two inches, depending on, for example, the length of blade 68, whether blade 68 includes one or more guides 64, and/or the hardness of the elastomeric material being severed. For example, blade 68 may have a thickness ranging from about one-quarter inch when blade 68 includes one or more guides 64, to about 1.5 inches when blade 68 does not include any guides 64 or similar supporting structure.

As shown in FIG. 11, exemplary mounting fixture 62 is configured to be operably coupled to a machine 90 (e.g., a backhoe loader) having an actuator 92 (e.g., a hydraulic or electric actuator). In this exemplary embodiment, mounting fixture 62 includes plate 78, which is configured to be operably coupled to a modified bucket 94 of machine 90. For example, exemplary modified bucket 94 shown in FIG. 11 has been modified so that the edge of the bucket lies substantially within a plane so that a receiver plate 96 may be operably coupled to modified bucket 94. Receiver plate 96 may be operably coupled to modified bucket 94 via known fastening methods, such as, for example, welding and/or fasteners such as bolts. Similarly, plate 78 of cutter 56 may be operably coupled to receiver plate 96 via known fastening methods, such as, for example, welding and/or fasteners such as bolts.

As shown in FIG. 11, cutter 56 may be operably coupled to actuator 92 of machine 90 via receiver plate 96, and actuator 92 of machine 90 may be operated to position cutter 56 relative to tire 24 so that tire 24 may be severed in a manner desired. For example, machine 90 may be operated such that one or more of guides 64 are aligned with cavities 33 of tire 24, and thereafter, actuator 92 may be activated such that cutter 56 is driven downward in a direction substantially perpendicular to an equatorial plane P of tire 24 (see FIG. 3), such that blade 68 severs the elastomeric material from one axial side of tire 24 to the opposite axial side of tire 24. Thereafter, actuator 92 may be activated so that cutter 56 reverses direction and is withdrawn from tire 24. In such an exemplary manner, cutter 56 may be used in a reciprocating manner to sever the elastomeric material of tire 24.

For example, actuator 92 may be operated such that blade 68 makes at least one cut into the elastomeric material resulting in removal of a tread portion 32 of tire 24. According to some embodiments, a plurality of cuts with blade 68 may be performed with a plurality of strokes of cutter 56 by operating actuator 92 to remove tread portion 32. For example, the cuts may be made in a sequential manner circumferentially around tire 24 to remove tread portion 32. According to some embodiments blade 68 may have a substantially circular cross-section and may be sized to remove tread portion 32 with a single stroke of cutter 56 into tire 24. For example, the radius of the curved or circular cross-section may be specifically dimensioned to remove the tread portion or support structure from tires or hubs having different diameters, for example, such that the tread portion and/or support structure may thereafter be remanufactured without further substantial processing following cutting with the blade. According to some embodiments, a plurality of cuts with blade 68 may be performed with a plurality of strokes of cutter 56 by operating actuator 92 such that blade 68 makes at least one cut into the elastomeric material resulting in removal of substantially all of the elastomeric material from hub 22 of tire 24. For example, the cuts may be made in a sequential manner circumferentially around tire 24 to remove support structure 34 and tread portion 32, for example, in an arrangement such as shown in FIG. 6. According to some embodiments blade 68 may have a substantially circular cross-section and may be sized to remove substantially all of the elastomeric material from hub 22 of tire 24 with a single stroke of cutter 56 into tire 24.

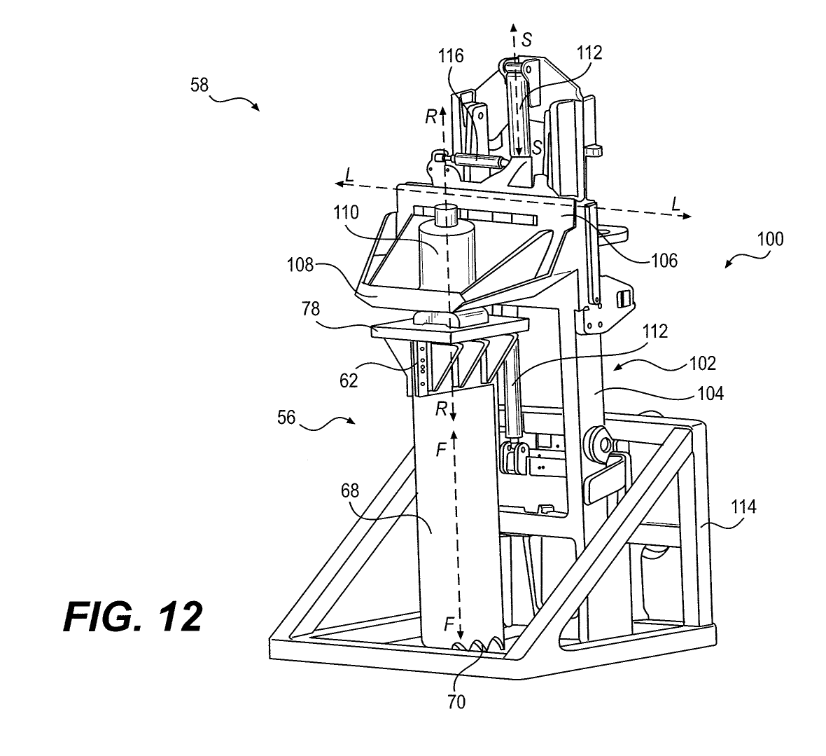

FIGS. 12-16 show exemplary embodiments of a cutter system 58 including a cutter 56 and a driver assembly 100. Cutter system 58 is configured to use cutter 56 to sever elastomeric material of tire 24. For example, FIG. 12 shows an exemplary embodiment of driver assembly 100 operably coupled to mounting fixture 62 of cutter 56. Exemplary driver assembly 100 includes a support member 102 including a support frame 104. Driver assembly 100 also includes a cross-member 106 operably coupled to support frame 104.

As shown in FIG. 12, exemplary cross-member 106 includes a tray 108 supporting an actuator 110 operably coupled to cutter 56. According to some embodiments, actuator 110 is a rotational actuator (e.g., a hydraulic and/or electric actuator) configured to rotate cutter 56 about an axis R, such that the orientation of blade 68 may be adjusted relative to support member 102 to facilitate severing the elastomeric material of tire 24 in different directions. According to the embodiment shown in FIG. 12, driver assembly 100 also includes an actuator 112 operably coupled to cross-member 106 and support member 102. Exemplary actuator 112 may be a linear actuator (e.g., a hydraulic actuator and/or electric actuator) configured to move cross-member 106, such that cutter 56 reciprocates along a first axis F relative to support member 102. For example, driver assembly 100 may include a base 114 onto which support member 102 is mounted. One end of actuator 112 may be operably coupled to base 114, and an opposite end of actuator 112 may be operably coupled to cross-member 106, such that extension and retraction of actuator 112 results in reciprocation of cross-member 106 and cutter 56.

According to some embodiments, cross-member 106 and support frame 104 are configured such that cross-member 106 is able to move in a direction along an axis L relative to support member 102 that is substantially perpendicular to an axis S of support member 102. Exemplary driver assembly 100 shown in FIG. 12 also includes an actuator 116 operably coupled to cross-member 106 and support member 102 and configured to move cross-member 106 along axis L relative to support member 102. For example, actuator 116 may be a linear actuator (e.g., a hydraulic and/or electric actuator) having one end operably coupled to support member 102 and an opposite end operably coupled to cross-member 106, such that operation of actuator 116 causes cross-member 106 and cutter 56 to move laterally relative to support member 102. This may further facilitate positioning of cutter 56 relative to tire 24. According to some embodiments, driver assembly 100 may have a structure at least similar to the mast of a fork truck, for example, a modified mast of a fork truck. Such embodiments may operate in a manner at least similar to a mast of a fork truck, with tray 108 being operably coupled to cutter 56, so that operation of the mast results in severing of the elastomeric material of tire 24.

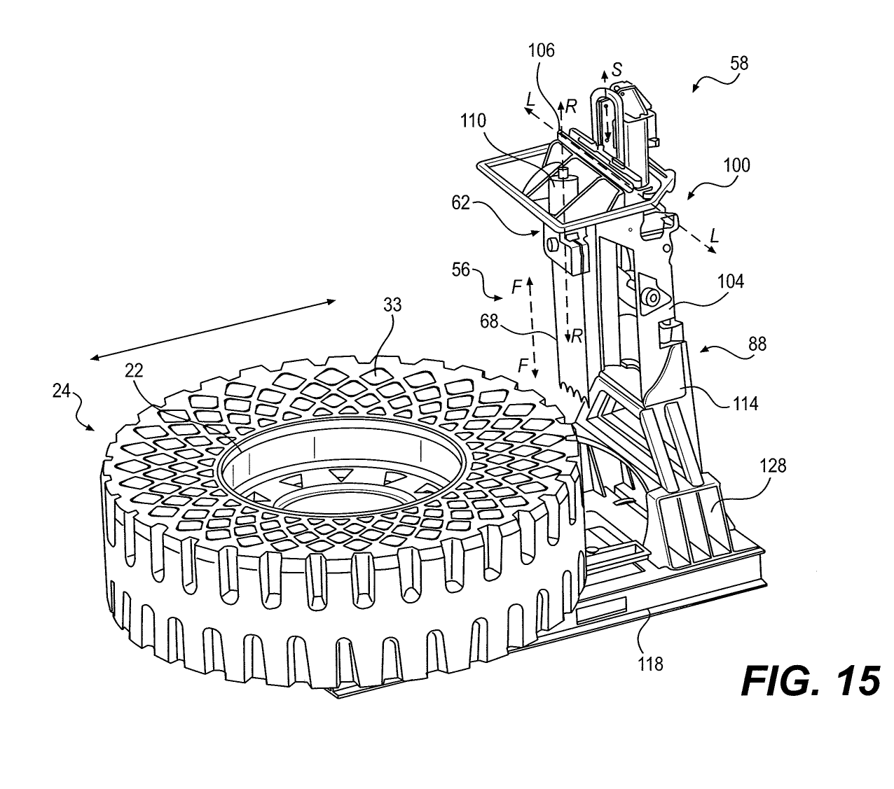

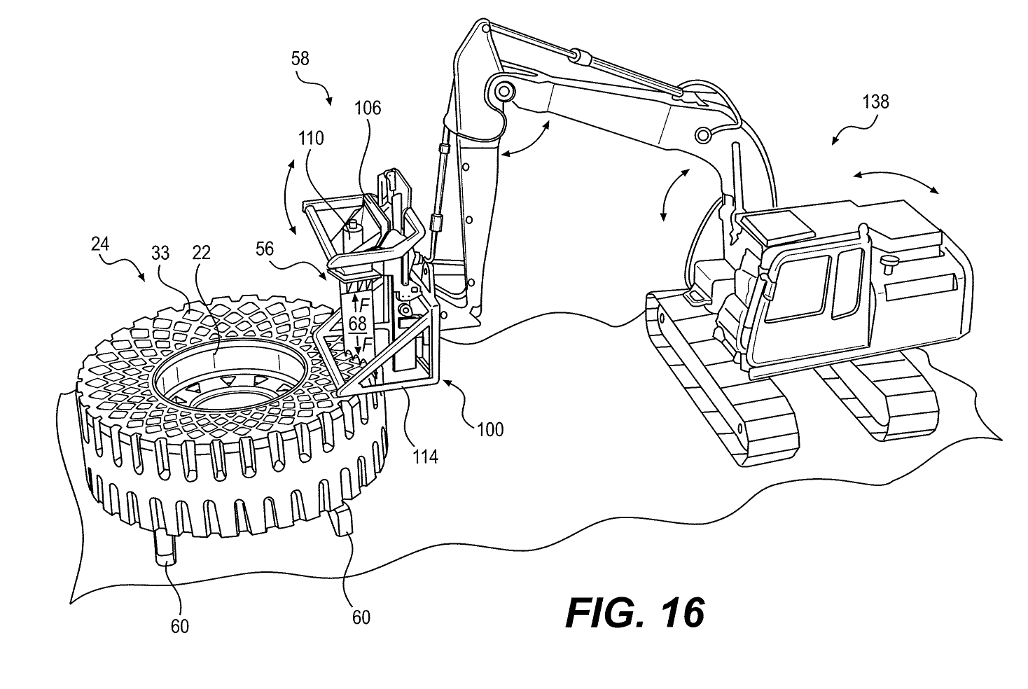

During exemplary operation of cutter system 58 shown in FIG. 12, driver assembly 100 may be positioned relative to tire 24, for example, as described with respect to FIGS. 15 and 16. Once driver assembly 100 has been positioned for severing of the elastomeric material, the positioning and/or orientation of cutter 56 relative to tire 24 may be adjusted (fine-tuned) by operation of actuator 110 and/or actuator 116, such that blade 68 has the desired orientation and/or position relative to tire 24. Actuator 112 may thereafter be operated such that blade 68 of cutter 56 is driven into the elastomeric material of tire 24, thereby cutting from one axial side of tire 24 to an opposite axial side of tire 24. Thereafter, actuator 112 may be operated in the reverse direction such that blade 68 is withdrawn from tire 24. Thereafter, actuator 110 and/or actuator 116 may be operated to reposition blade 68 for the next cut into tire 24, for example, by adjusting the orientation and/or position. Following repositioning of blade 68, actuator 112 may be activated such that blade 68 is driven into and withdrawn from tire 24 in a reciprocating manner. This exemplary process may be repeated until tire 24 has been severed as desired.

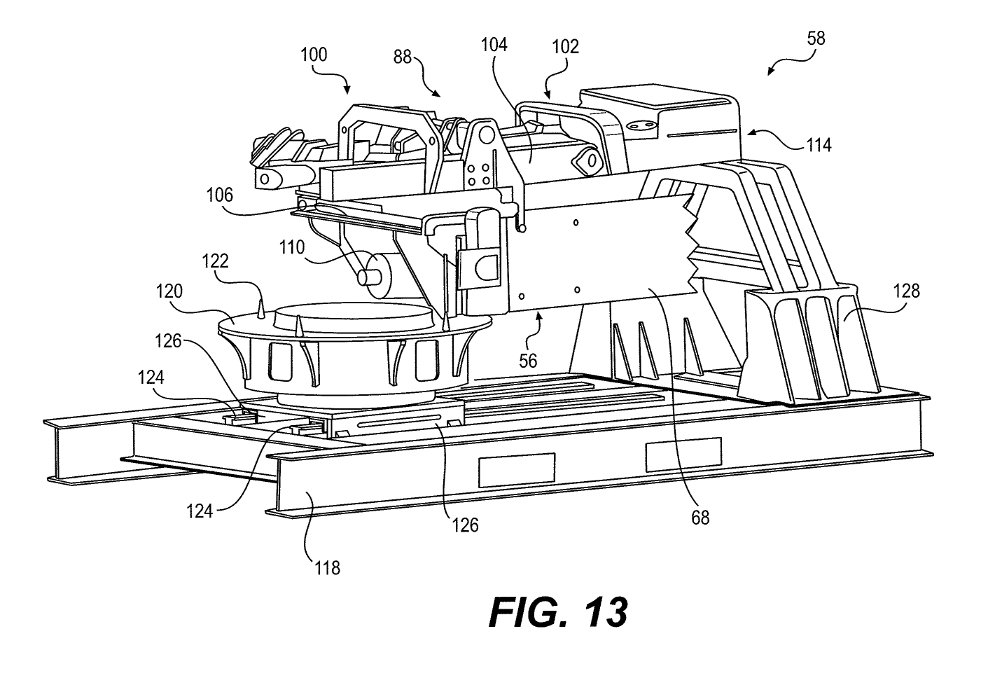

According to some embodiments, driver assembly 100 may be coupled to a machine to facilitate positioning of cutter 56 relative to tire 24, such as, for example, shown in FIGS. 13-16. For example, as shown in FIGS. 13-15, driver assembly 100 may be coupled to a platform 118. According to some embodiments, platform 118 may take the form of, for example, a modified shipping platform.

As shown in FIGS. 13-15, exemplary platform 118 includes a chuck 120 operably coupled to platform 118 and configured to selectively secure tire 24 to platform 118. For example, chuck 120 may include pins and/or connectors 122 configured to locate and/or secure tire 24 on chuck 118 during severing of the elastomeric material. According to some embodiments, chuck 120 may be configured to selectively rotate relative to platform 118. According to some embodiments, chuck 120 may be configured not to rotate relative to platform 118.

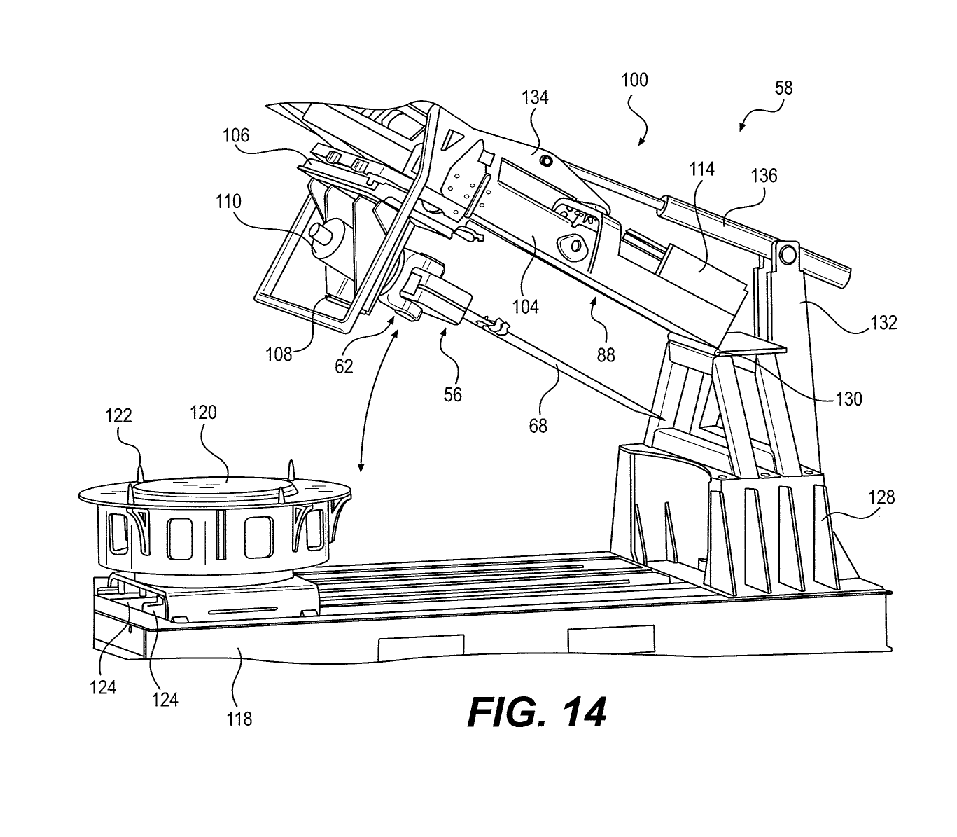

As shown in FIGS. 13 and 14, chuck 120 and platform 118 may be configured such that chuck 120 is moveable on platform 118 relative to driver assembly 100. For example, platform 118 may include rails 124, and chuck 120 may include guides 126 (e.g., sliders) receiving rails 124, such that chuck 120 is moveable relative to platform 118 toward and away from driver assembly 100. According to some embodiments, an actuator (e.g., a linear hydraulic and/or electric actuator) may be coupled to platform 118 and chuck 120 to facilitate ease of movement of chuck 120. This may render it relatively easier to move tire 24 to a desired position relative to driver assembly 100.

According to some embodiments, driver assembly 100 and/or platform 118 may be configured such that driver assembly 100 may be selectively moveable between a first, collapsed orientation relative to platform 118, for example, as shown in FIG. 13, to a second, upright orientation relative to platform 118, for example, as shown in FIG. 15. As shown in FIGS. 13-15, platform 118 may include a mounting base 128, and a hinge 130 may be provided to operably couple support member 102 (e.g., base 114) to mounting base 128 of platform 118, thereby pivotally coupling driver assembly 100 to platform 118. As shown in FIG. 14, according to some embodiments, platform 118 includes a tower 132, and driver assembly 100 includes a boss 134. The exemplary embodiment shown includes an actuator 136 (e.g., a linear hydraulic and/or electric actuator) having one end coupled to tower 132 and an opposite end coupled to boss 134, such that operation of actuator 136 moves driver assembly 100 between the first, collapsed orientation relative to platform 118 and the second, upright orientation relative to platform 118. The collapsed position may facilitate transport of cutter system 58, including cutter 56, driver assembly 100, and platform 118, between locations of use.

FIG. 15 shows an exemplary tire 24 mounted on chuck 120 on platform 118 with cutter system 58, including driver assembly 100 and cutter 56, in the upright orientation for use. During exemplary operation of cutter system 58 shown in FIG. 15, tire 24 may be mounted on chuck 120, and chuck 120 may be positioned relative to driver assembly 100 using an actuator coupled to chuck 120 and platform 118.

Once tire 24 has been moved into the desired position relative to driver assembly 100, the positioning and/or orientation of cutter 56 relative to tire 24 may be adjusted by operation of actuator 110 and/or actuator 116, such that blade 68 has the desired orientation and/or position relative to tire 24. Actuator 112 may thereafter be operated such that blade 68 of cutter 56 is driven into the elastomeric material of tire 24, thereby cutting from one axial side of tire 24 to an opposite, axial side of tire 24. Thereafter, actuator 112 may be operated in the reverse direction, such that blade 68 is withdrawn from tire 24. Thereafter, the position of tire 24 may be repositioned relative to driver assembly 100 by movement of chuck 120 relative to platform 188, as previously described. Thereafter, actuator 110 and/or actuator 116 may be operated to reposition blade 68 for the next cut into tire 24, for example, adjusting the orientation and/or position. Following repositioning of blade 68, actuator 112 may be activated such that blade 68 is driven into and withdrawn from tire 24 in a reciprocating manner. This exemplary process may be repeated until tire 24 has been severed as desired.

According to some embodiments, driver assembly 100 may be configured to be operably coupled to a machine 138, for example, such as the exemplary excavator shown in FIG. 16. Machine 138 may be used to position driver assembly 100 relative to tire 24, and hold driver assembly 100 in place while cutter system 58 is operated to cut tire 24. For example, support member 102 of driver assembly 100 may include a coupling system, such as, for example, known coupling systems for coupling work tools to machines.

As shown in FIG. 16, tire 24 may be placed on top of supports 60 such that the weight of tire 24 is supported at hub 22 rather than the by the elastomeric material of tire 24. This may render it relatively easier to cut into and withdraw blade 68 of cutter 56 when severing the elastomeric material, as the substantially unsupported weight of the elastomeric material tends to pull itself apart or away from blade 68 as the material is severed. Supports 60 may include one or more beams having a large enough cross-sectional dimension to provide sufficient clearance for blade 68 to cut completely from one axial side of tire 24 to the opposite axial side of tire 24 without blade 68 being driven into the ground or support surface under supports 60.

During exemplary cutting of tire 24 shown in FIG. 16, tire 24 may be mounted on support 60. Machine 138 may be used to position driver assembly 100 relative to tire 24 for desired cutting. Thereafter, the positioning and/or orientation of cutter 56 relative to tire 24 may be adjusted by operation of actuator 110 and/or actuator 116 of driver assembly 100, such that blade 68 has the desired orientation and/or position relative to tire 24. Actuator 112 may thereafter be operated such that blade 68 of cutter 56 is driven into the elastomeric material of tire 24, thereby cutting from one axial side of tire 24 to an opposite side of tire 24, with machine 138 holding driver assembly 100 in a substantially fixed position. Thereafter, actuator 112 may be operated in the reverse direction such that blade 68 is withdrawn from tire 24. Machine 138 may then be operated to reposition driver assembly 100 in a desired position and orientation relative to tire 24 for making the desired cut. Actuator 110 and/or actuator 116 may then be operated to fine tune the position of blade 68 for the next cut into tire 24, for example, adjusting the orientation and/or position. Following repositioning of blade 68, actuator 112 may be activated such that blade 68 is driven into and withdrawn from tire 24 in a reciprocating manner. This exemplary process may be repeated until tire 24 has been severed as desired.

### INDUSTRIAL APPLICABILITY

The non-pneumatic tires disclosed herein may be used with any machines, including self-propelled vehicles or vehicles intended to be pushed or pulled by another machine. According to some embodiments, the non-pneumatic tires may be molded, non-pneumatic tires having a tread portion formed integrally as a single piece with the remainder of the tire to form a single, monolithic structure. With use, the tread portion may become worn beyond a point rendering the tire unsuitable for its intended use. In addition, the remaining molded portions of the tire may become worn or damaged with use. For example, the elastomeric material between the tread portion and the hub may become damaged or cracked through fatigue. Thus, it may be desirable to remove the tread portion and/or the remaining elastomeric material portions of the non-pneumatic tire from the hub, for example, so the hub can be reused to form a remanufactured non-pneumatic tire.

According to some embodiments, the cutters, cutter systems, and methods disclosed herein may facilitate removal of at least a portion of the tread portion, such that the remaining portion of the tire is suitable for molding a new tread portion onto the remaining portion of the tire. Further, according to some embodiments, the cutters, cutter systems, and methods disclosed herein may facilitate removal of the elastomeric portions of the tire from the hub, such that the hub is suitable for molding new elastomeric material thereon to form a new non-pneumatic tire. In addition, according to some embodiments, the cutters, cutter systems, and methods disclosed herein may be used to remove portions of elastomeric material from non-pneumatic tires to permit evaluation the characteristics of the elastomeric material following molding of the tire.

It will be apparent to those skilled in the art that various modifications and variations can be made to the exemplary disclosed cutters, cutter systems, and methods. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A cutter system configured to sever elastomeric material of a non-pneumatic tire, the cutter system comprising:
a cutter including a mounting fixture and a blade coupled to the mounting fixture, wherein the blade includes a cutting edge configured to sever the elastomeric material; and
a driver assembly operably coupled to the mounting fixture of the cutter, wherein the driver assembly includes:
a support member,
a cross-member operably coupled to the mounting fixture of the cutter and the support member,
a first actuator operably coupled to the cross-member and the mounting fixture of the cutter, the first actuator being configured to rotate the mounting fixture of the cutter relative to the cross-member, and
a second actuator operably coupled to the cross-member and the support member, wherein the second actuator is configured to move the cross-member, such that the cutter reciprocates along a first axis relative to the support member.

2. The cutter system of claim 1, further including a third actuator operably coupled to the cross-member and the support member, wherein the third actuator is configured to move the cross-member along a second axis substantially perpendicular to the first axis.

3. The cutter system of claim 1, wherein the first actuator includes a rotational actuator.

4. The cutter system of claim 1, wherein at least one of the second and third actuators includes a linear actuator.

5. The cutter system of claim 1, wherein the driver assembly is configured to be operably coupled to a machine configured to position the driver assembly relative to the non-pneumatic tire.

6. The cutter system of claim 1, further including a platform configured to support a non-pneumatic tire during severing of the elastomeric material, wherein the driver assembly is operably coupled to the platform.

7. The cutter system of claim 6, wherein the driver assembly is pivotally coupled to the platform such that the driver assembly is selectively movable between a first, collapsed orientation relative to the platform and a second, upright orientation relative to the platform.

8. The cutter system of claim 7, further including a fourth actuator operably coupled to the platform and the driver assembly, wherein the fourth actuator is configured to move the driver assembly between the first orientation and the second orientation.

9. The cutter system of claim 6, further including a chuck operably coupled to the platform and configured to selectively secure a non-pneumatic tire with respect to the platform.

10. The cutter system of claim 9, wherein at least one of the chuck and platform are configured such that the chuck is selectively moveable relative to the driver assembly.

11. A method for removing elastomeric material from a non-pneumatic tire, the method comprising:
placing a non-pneumatic tire on a support;
positioning a cutter system relative to the non-pneumatic tire, the cutter system being configured to sever a portion of the elastomeric material, wherein the cutter system includes:
a cutter including a blade having a cutting edge configured to sever the elastomeric material, and
a driver assembly operably coupled to cutter, wherein the driver assembly includes:
a support member operably coupled the cutter, and
an actuator operably coupled to the cutter and the support member, the actuator being configured such that upon activation the cutter reciprocates along a first axis substantially perpendicular to an equatorial plane of the non-pneumatic tire; and
activating the actuator such that the cutter severs a portion of the elastomeric material.

12. The method of claim 11, wherein the support includes a chuck configured to be operably coupled to the non-pneumatic tire, and wherein placing the non-pneumatic tire on the support includes coupling the non-pneumatic tire to the chuck.

13. The method of claim 12, wherein the support includes a platform to which the chuck is operably coupled such that it is selectively movable relative to the platform, and wherein placing the non-pneumatic tire on the support further includes moving the chuck relative to the platform toward the driver assembly.

14. The method of claim 11, wherein the actuator is a first actuator, and the driver assembly includes a second actuator configured to rotate the blade, and wherein the method further includes activating the second actuator to rotate the blade from a first orientation to a second orientation, and activating the first actuator such that the cutter severs a second portion of the non-pneumatic tire.

15. The method of claim 11, wherein positioning the cutter system relative to the non-pneumatic tire includes moving the cutter system relative to the non-pneumatic tire via a machine.

16. The method of claim 15, wherein the machine includes a boom operably coupled to the driver assembly, and wherein positioning the cutter system relative to the non-pneumatic tire includes moving the boom.

17. The method of claim 11, wherein the method includes removing a tread portion from the non-pneumatic tire by severing the elastomeric material.

18. The method of claim 17, wherein removing the tread portion from the non-pneumatic tire includes making a plurality of cuts with the cutter circumferentially around the non-pneumatic tire to remove the tread portion.

19. The method of claim 11, wherein the non-pneumatic tire includes a hub, and wherein the method includes substantially removing the elastomeric material from the hub by severing the elastomeric material.

20. The method of claim 19, wherein substantially removing the elastomeric material from the hub includes making a plurality of cuts with the cutter to remove portions of the elastomeric material.
